(19) United States
(12) Patent Application Publication
(10) Pub. No.: US 2021/0272074 A1
(43) Pub. Date: Sep. 2, 2021

(54) SYSTEMS AND METHODS FOR FACILITATING RECYCLING

(71) Applicant: SOS Solutions, Inc., Tonasket, WA (US)

(72) Inventors: Samuel R. Peacemaker, Gilbert, AZ (US); Benjamin Peacemaker, Chandler, AZ (US)

(73) Assignee: SOS Solutions, Inc., Tonasket, WA (US)

(21) Appl. No.: 17/182,824

(22) Filed: Feb. 23, 2021

Related U.S. Application Data
(60) Provisional application No. 62/983,332, filed on Feb. 28, 2020.

(51) Int. Cl. G06Q 10/00; G06Q 30/02

(52) U.S. Cl. CPC G06Q 10/30; G06K 7/1413; G06Q 30/0208

(57) ABSTRACT

A method is provided comprising receiving, at a recycling facilitation system, a container identifier, authenticating, by the recycling facilitation system, the container identifier, determining, by the recycling facilitation system, at least one of the availability or identity of an incentive, and distributing, by the recycling facilitation system, the incentive. A method is further provided comprising receiving, at an incentive system, an authenticated container identifier, determining, by the incentive system, at least one of the availability or identity of an incentive, and distributing, by the incentive system, the incentive.

### CROSS REFERENCE TO RELATED APPLICATIONS

This application is a nonprovisional of, and claims priority to, U.S. Provisional Application No. 62/983,332, entitled “SYSTEMS AND METHODS FOR FACILITATING RECYCLING” and filed on Feb. 28, 2020, which is hereby incorporated by reference for all purposes.

### FIELD

The present disclosure generally relates to systems and methods for facilitating recycling.

### BACKGROUND

Recycling, especially recycling of containers, is an important way to conserve non-renewable resources. According to the U.S. National Institutes of Health (“NIH”), it takes 95% less energy to recycle aluminum than it does to refine aluminum from raw materials. Moreover, according to the NIH, recycled plastics save 70% of production energy and recycled glass 40% saves of production energy. This is not to mention water consumed or wasted during the production of these materials from their raw materials.

In that regard, recycling is environmentally and economically beneficial. However, consumers may need incentivization to participate in recycling programs. For decades, state run container legislation regimes have provided consumers an incentive to recycle, as well as providing a deterrent to littering. States may collect a deposit on each container produced and may refund that amount to the presenter of a used container for recycling. Deposit amounts vary state to state and container material, but are often in the range of 5 cents to 15 cents per container. These state-run container legislation regimes require consumers to separate bottles, cans and other containers with redeemable value, from other recyclable items. They then require consumers to find the nearest container drop off center, load up all their containers with redeemable value in their vehicle, drive to a container drop off location, and scan each container with redeemable value one by one to receive the cash value of those containers. Having to complete all these steps to redeem the cash value of the recyclable container can be burdensome to the consumer and in turn can lead to fewer items being recycled. This time consuming, burdensome process may cause a consumer to procrastinate and/or abandon their recycling efforts altogether. Even without a state run container legislation regime, governments may want to encourage recycling in other ways to reduce litter and extend the life of government owned landfills.

### SUMMARY

A method is provided comprising receiving, at a recycling facilitation system, a container identifier, authenticating, by the recycling facilitation system, the container identifier, determining, by the recycling facilitation system, at least one of the availability or identity of an incentive, and distributing, by the recycling facilitation system, the incentive.

A method is provided comprising receiving, at an incentive system, an authenticated container identifier, determining, by the incentive system, at least one of the availability or identity of an incentive, and distributing, by the incentive system, the incentive.

A recycling facilitation receptacle is provided comprising at least one of a lid or a vessel coupled to a recycling interface, the recycling interface comprising an optical sensor in electronic communication with a processor and a tangible, non-transitory memory configured to communicate with the processor, the tangible, non-transitory memory having instructions stored thereon that, in response to execution by the processor, cause the processor to perform operations comprising receiving, by the processor and from the optical sensor, a container identifier and transmitting, by the processor and to a recycling facilitation system, the container identifier.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 shows a recycling facilitation distributed system, in accordance with various embodiments;

FIG. 2 shows a recycling facilitation receptacle, in accordance with various embodiments;

FIG. 3 shows a recycling facilitation distributed system, in accordance with various embodiments;

FIG. 4 shows a recycling facilitation distributed system, in accordance with various embodiments;

FIG. 5 shows a labeling system, in accordance with various embodiments;

FIG. 6 shows a recycling facilitation method, in accordance with various embodiments;

FIG. 7 shows a recycling facilitation method, in accordance with various embodiments;

FIG. 8 shows a recycling facilitation distributed system, in accordance with various embodiments; and

FIG. 9 shows a recycling facilitation distributed system, in accordance with various embodiments.

### DETAILED DESCRIPTION

As discussed above, consumers may need incentives, for example, monetary incentives, to encourage recycling. Moreover, consumers may need systems to make recycling more simple and convenient. By removing or reducing the hassle and time (i.e., the “friction”) of recycling, systems and methods in various embodiments may improve recycling participation rates and thus act to improve the environment.

In that regard, in various embodiments, recycling facilitation system is disclosed that may identify individual containers so that they may be presented for recycling and processed for payment of an incentive simultaneously, nearly simultaneously, and/or within a time period of several minutes to several days. By tracking the individual container, incentive processing may be substantially shortened as well as broadly distributed to locations not available using existing systems.

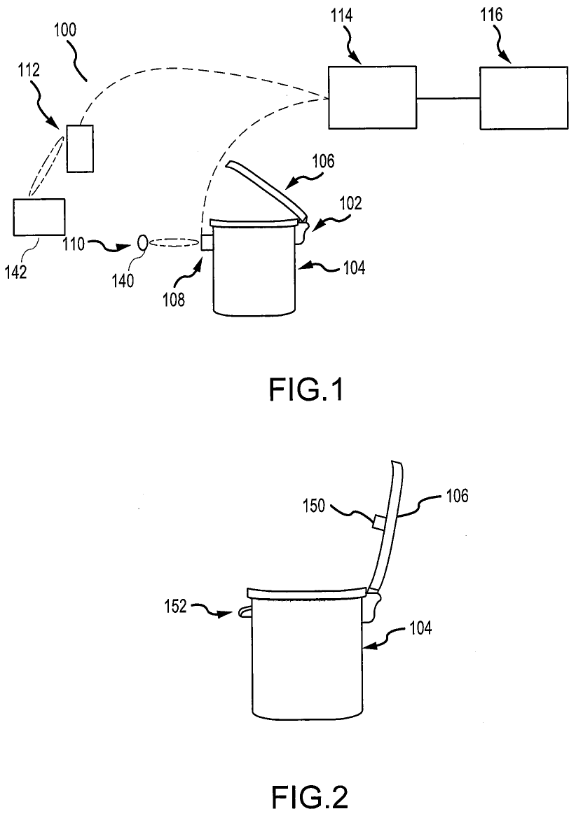

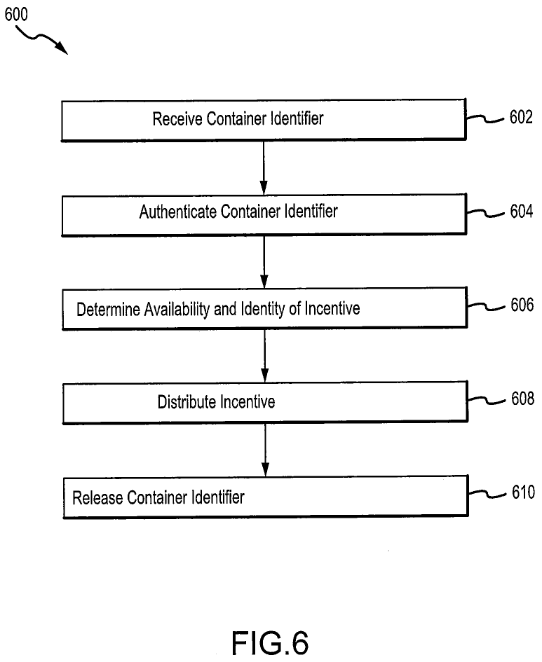

With reference to FIGS. 1 and 6, recycling facilitation distributed system 100 is illustrated with method 600. In recycling facilitation distributed system 100, recycling facilitation receptacle 102 is shown disposed near container 110. Recycling facilitation receptacle 102 comprises lid 106 and vessel 104. Vessel 104 may be configured to house an inner bag, such as a plastic bag, to house containers to be recycled. Lid 106 may be configured to pivot or rotate relative to vessel 104 to allow selective access to vessel 104 while in use while closing and/or sealing with vessel 104 to obscure the contents therein and contain odors. Lid 106 may pivot or rotate by manual use, by operation of a foot pedal, hand lever, or actuation of a motor that is responsive to motion or light. Vessel 104 and lid 106 may thus be coupled via a hinge or other suitable coupling that allows for pivoting or rotation.

Recycling facilitation receptacle 102 may be located in a personal residence or a business. In that manner, activity of recycling facilitation receptacle 102 may be linked to user device 112. By linking recycling facilitation receptacle 102 to user device 112, various parameters may be set by user device 112, including preferred incentive forms, preferred accounts for receiving incentives, and other data involving activity history and location. In further embodiments, recycling facilitation receptacle 102 may be placed in a public place, such as a city street, a mall, an airport, a train system, a hotel, at an event site such as a sporting event, and/or any other place where the public may pass or gather.

Vessel 104 is coupled to recycling interface 108, though with momentary reference to FIG. 2, lid 106 may be coupled to recycling interface 108 and handle 152 may be disposed on vessel 104. Recycling interface 108 may be coupled to vessel 104 and/or lid 106 in any suitable manner and, in various embodiments, is removably coupled to vessel 104 and/or lid 106. Recycling interface 108 comprises one or more of a processor, an optical sensor, a laser sensor, an NFC interface, a Bluetooth interface, a wireless Ethernet (e.g., WiFi) interface, a cellular device, and a memory, as further described herein. In that regard, recycling interface may receive or perceive a container identifier 140 from a container, such as container 110. Container 110 may be any container or other object intended for recycling. For example, container 110 may comprise a plastic bottle, an aluminum can, a tin can, a steel can, a glass bottle (of any color), a cardboard box, a newspaper, or other recyclable item. Container 110 may comprise plastics bearing recycling labels 1, 2, 3, 4, 5, 6, and 7, or stated another way, container 110 may comprise plastic comprises of Polyethylene Terephthalate/PETE, High density Polyethylene/HDPE, Polyvinyl Chloride/V, Low-density Polyethylene/LDPE, Polypropylene/PP, Polystyrene/PS, or Other plastics such as mixtures of the foregoing.

Recycling interface 108 is in electronic communication with recycling facilitation system 114. Recycling facilitation system 114 is thus configured to exchange data with recycling interface 108, for example, via the Internet as described herein. Recycling interface 108 is in electronic communication with incentive system 116. Incentive system 116 is thus configured to exchange data with recycling facilitation system 114. Incentive system 116 may be operated by an incentive sponsoring entity, such as a governmental entity or agency, that provides incentives for recycling. In this manner, incentive sponsoring entity may collect deposits from container manufactures or distributors in a respective jurisdiction to form a repository of funds available to award incentives for recycling. In various embodiments, the incentive sponsoring entity is a private business that offers incentives to recycle its products or product packaging/shipping materials. For example, an eCommerce business may offer an incentive to promote recycling its shipping boxes. In various embodiments, incentives may be in the form of U.S. or other national currency, cryptocurrency, merchant gift cards or other credit at a merchant, financial services loyalty rewards points, or points in a rewards account that accumulate over time and may be redeemed for rewards such as various goods and services. As a consumer may recycle containers associated with a variety of incentive sponsoring entities, recycling facilitation system 114 may allow a consumer the ability to convert an incentive from one incentive sponsoring entity to a different form. In that regard, a 5 cent deposit refund from a state may be converted in recycling facilitation system 114 to points to be redeemed at a later time or for credit at a particular merchant. This conversion may occur at preferred or discounted rate to promote use of such inventive in different formats. Thus, in various embodiments, a 5 cent deposit refund from a state may be converted by recycling facilitation system 114 to a 6 cent credit with a merchant. Moreover, points accumulation may be encouraged by recycling facilitation system 114 by offering increased incentive payments during conversion of larger point amounts. For example, a 5 cent deposit refund from a state may be converted to a 5 points in a rewards account held by recycling facilitation system 114. Recycling facilitation system 114 may redeem 1 point to 1 cent for redemptions below 10,000 points at one time and 1.5 cents to 1 point on redemptions over 10,000 points at one time. In this manner, recycling facilitation system 114 may reduce transaction costs associated with paying incentives as well as retain the funds given by incentive system 116 for a longer period of time as consumers build their rewards account to higher levels.

Recycling interface 108 may comprise a replaceable battery that may be either disposable or rechargeable. For example, the batteries of recycling interface 108 may be recharged periodically or plugged into a source of electrical power. In public deployments, one or more solar panels may be electrical coupled to recycling interface 108 for environmentally friendly, “off the grid” charging.

Recycling interface 108 is configured to couple to a network, as described herein. Where recycling interface 108 connects to the Internet, IP address data may be shared between recycling interface 108 and recycling facilitation system 114. Recycling facilitation system 114 may then determine the general geographic location of recycling interface 108 by ascertaining such information based on the IP address data passed from recycling interface 108. For example, recycling facilitation system 114 may reference the IP address data passed from recycling interface 108 in a WHOIS database or similar database that generally maps IP addresses to physical localities. Recycling facilitation system 114 may, in turn, pass this geographic location to incentive system 116.

Geographic location determination may used in various embodiments to enforce recycling rules. For example, recycling facilitation system 114 may verify that the geographic location associated with recycling interface 108 in fact has curbside recycling services available. In this manner, it can be reasonably assured that containers deposited into recycling facilitation receptacle 102 will in fact be recycled through local curbside recycling services. If recycling facilitation system 114 determines that a geographic location associated with recycling interface 108 does not have curbside recycling services available, recycling facilitation system 114 may deny a transaction until such time as recycling interface 108 is brought into a geography that has curbside recycling services available.

User device 112 is in electronic communication with recycling facilitation system 114. User device 112 is thus configured to exchange data with recycling facilitation system 114. User device 112 may comprise a phone, tablet, or other device running an application or a web client. User device 112 may be communication with various financial services applications, accounts, and cryptocurrency accounts and eWallets. In that regard, financial transactions may be made by user device 112 to move funds from recycling facilitation system 114 to an account or medium desired by user device 112. In embodiments where recycling facilitation receptacle 102 is deployed in a public space, user device 112 may interface with recycling interface 108 to pass identification of user device 112 to recycling interface 108 and via recycling interface 108 to recycling facilitation system 114. In this manner, the appropriate user device 112 in which to credit the incentive is determined. This relationship is shown in FIG. 4, illustrating user device 112 communicating with recycling interface 108. This communication may be accomplished by a communications interface via any format described herein, for example, via WiFi, Bluetooth, NFC or the optical recognition of a bar code or QR code. Notably, where recycling interface 108 is in a home setting, identification of user device 112 to recycling interface 108 need only occur once to link the user device 112 to recycling interface 108. Multiple recycling transactions may then occur subsequently. In contrast, in public deployments, identification of user device 112 to recycling interface 108 may occur prior to each recycling transaction or a set of recycling transactions.

With continued reference to FIGS. 1 and 6, container 110 may be presented to recycling interface 108 for recycling and thus recycling interface 108 may obtain the container identifier 140. Container 110 has associated with a container identifier 140. The contain identifier may be at least one of a text string (for example, text containing American Standard Code for Information Interchange (“ASCII”) characters), a bar code, a Quick Response (“QR”), and/or alphanumeric characters. The container identifier 140 may be encrypted, digitally signed via cryptography, or be unencrypted. With momentary reference to FIG. 5, the container identifier 140 may comprise a unique code that has a digital signature applied to create a signed code. The container identifier 140 may be displayed on the container via a bar code, QR code, or other printing on the container and/or a label associated with the container. The container identifier 140 may be scanned by an optical and/or laser scanner of recycling interface 108. In various embodiments, the container identifier 140 is embodied on an RFID or other embedded device associated with container 110 and may present the container identifier 140 to recycling interface 108 via NFC or other touchless/wireless system.

Upon obtaining the container identifier 140, recycling interface 108 may transmit the container identifier 140 to recycling facilitation system 114, and thus recycling facilitation system 114 may receive the container identifier 140 (step 602). In that regard, recycling facilitation system 114 may log or otherwise note the receipt of the container identifier 140. Recycling facilitation system 114 may, in various embodiments, authenticate a digital signature on the container identifier 140 and/or decrypt the container identifier 140. After authentication of the container identifier 140, recycling facilitation system 114 may lookup the container identifier 140 to authenticate the container identifier 140 (step 604). Looking up the container identifier 140 may comprise searching a database accessible to recycling facilitation system 114 (whether contained within recycling facilitation system 114 or via an external database connection and/or API and/or SQL connection and/or RDBMS connection). For example, incentive system 116 may contain a database of valid container identifiers, though in various embodiments recycling facilitation system 114 contains the databases used to verify the container identifiers. Recycling facilitation system 114 thus matches the container identifier 140 with one or more databases to determine whether the container identifier 140 is valid. In this manner, the origination of the container identifier 140 may be determined by such a match in the one or more databases.

Once a container identifier 140 is matched against a database, recycling facilitation system 114 may determine the availability and identity of an incentive (step 605). In this manner, recycling facilitation system 114 may communicate with incentive system 116. Recycling facilitation system 114 may be in communication with multiple incentive systems 116, though one is shown for ease of illustration.

Incentive system 116, as described above, may be associated with an incentive sponsoring entity such as governmental agency, a merchant, or other private entity. Incentive system 116 may determine whether the container identifier 140 is associated with an available inventive. If an incentive is available, the incentive system 116 may report the same availability and identity of the incentive to the recycling facilitation system 114 and update its own records to note that the particular container identifier 140 has been redeemed and note the time stamp associated with such redemption. The identity of the incentive comprises the amount of the incentive and the form of the incentive, such as a currency payment, a merchant credit, etc. If an incentive is not available, the incentive system 116 may report the same to the recycling facilitation system 114 and update its own records to note that an attempt to redeem a particular container identifier 140 has already previously been redeemed and note the time stamp associated with such redemption. In this manner, one container identifier 140 may only be redeemed once, unless and until recycling facilitation system 114 releases the container identifier 140 at a later time. Stated another way, incentive system 116 may transmit a determination of whether the container identifier 140 has previously been recognized by the incentive system 116 to the recycling facilitation system 114. This prevents the issue of fraudulent redemptions and/or duplicate redemptions for the same container identifier 140. Incentive system 116 may render payment to recycling facilitation system 114 in response to a finding of an available incentive, though in various embodiments, incentive system 116 may aggregate multiple transactions and pay recycling facilitation system 114 in a batch manner, such as once per week or once per month. In various embodiments, however, recycling facilitation system 114 may verify the availability and identity of the incentive itself and update its records indicating the same.

As discussed above, recycling facilitation system 114 may pass geographic location of recycling interface 108 to incentive system 116. In that regard, incentive system 116 may use the geographic location of recycling interface 108 in determining the availability and identity of an incentive (step 605). If, for example, the geographic location does not correspond to a locality within the service area of an incentive sponsoring entity, the incentive system 116 may determine that no incentive is available based on geographic ineligibility. Or, for example, if the geographic location does not correspond to a locality with curbside recycling services available, the incentive system 116 may determine that no incentive is available based on geographic location because it would not be likely that the container was in fact submitted for recycling.

Recycling facilitation system 114 may distribute the incentive (step 608) to receiving account 142. For example, the recycling facilitation system 114 may make a cash deposit into an account associated with user device 112, or recycling facilitation system 114 may transfer cryptocurrency to a predetermined eWallet input by user device 112, or recycling facilitation system 114 may deposit a merchant credit or gift card to a merchant account associated with user device 112. In this regard, receiving account 142 may comprise a bank account, merchant account, gift card account, cryptocurrency eWallet, financial services loyalty rewards account, and/or a rewards account maintained by or in association with recycling facilitation system 114. As described above, recycling facilitation system 114 may retain a rewards points system that increments a number of points consistent with the incentive payment of incentive system 116 to a user account associated with user device 112 to be redeemed at a later time.

Recycling facilitation system 114 may distribute the incentive (step 608) to receiving account 142 within 1 second to 12 hours or within 1 second and 24 hours of the completion of step 606. By having “real time” rewards, consumers may be further incentivized to recycle, as their recycling activities derive immediate economic benefit. In that regard, a consumer may be able to earn funds immediately while at home. There is no need to travel to a centralized recycling center, but instead the consumer has the convenience of typical curbside recycling services.

Recycling facilitation system 114 may then release the container identifier 140 (step 610) after the incentive has been distributed. In this manner, recycling facilitation system 114 may update its database or a database to which it has access to record data surrounding the redemption of the container identifier 140 and allow issuance of that container identifier 140 to additional containers.

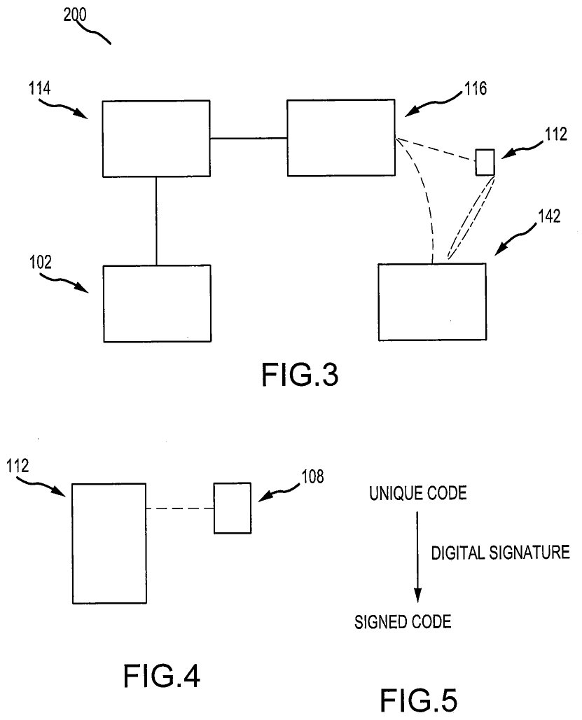

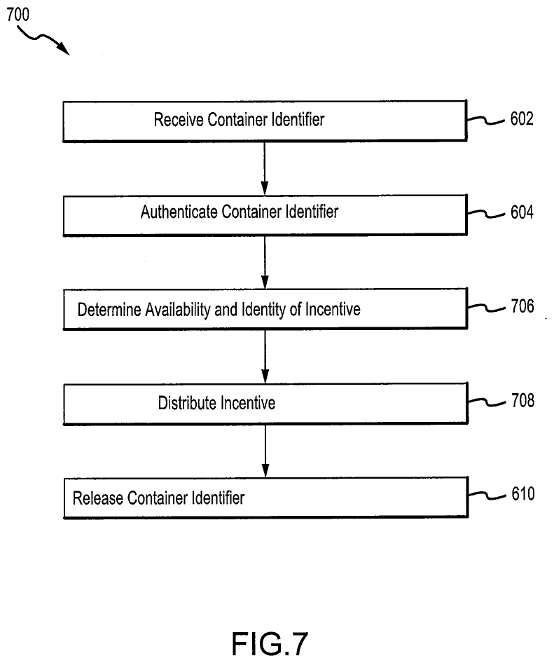

With reference to FIGS. 3 and 7, recycling facilitation distributed system 200 and method 700 are illustrated. Recycling facilitation distributed system 200 is similar to recycling facilitation distributed system 100 and method 700 is similar to method 600, except where noted. In recycling facilitation distributed system 200, incentive system 116 is in direct communication with user device 112 and/or receiving account 142. In this manner, incentive system 116 may distribute incentive directly to receiving account 142. In that regard, the determination of availability and identity of an incentive remains with incentive system 116 (step 706) and the distribution of the incentive (step 708) occurs from the incentive system 116.

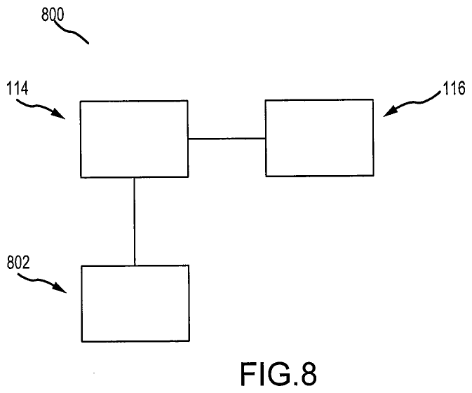

With reference to FIG. 8, a recycling facilitation distributed system 800 is shown. In recycling facilitation distributed system 800, recycling facilitation system 114 is in communication with incentive system 116 and container manufacturer/distributor 802. In this manner, recycling facilitation system 114 may maintain a database of available container identifiers to communicate to incentive system 116 and container manufacturer/distributor 802. In this manner, container manufacturer/distributor 802 may use a unique container identifier per container and incentive system 116 may be informed of which container manufacturer/distributor 802 is associated with the container identifier. In this manner, payments by container manufacturer/distributor 802 may be properly tracked by incentive system 116 and/or recycling facilitation system 114. Moreover, the uniqueness of container identifiers may be maintained by having recycling facilitation system 114 issue container identifiers to container manufacturer/distributor 802 until such container identifiers are redeemed and then released back to container manufacturer/distributor 802 for placement on additional containers. In various embodiments, however, such release may not occur and each container identifier is used only once. Given the ability of a QR code to contain up to 1028 characters and given that even using only alpha numeric characters without differentiating between upper case and lower case letters there are 36 possible characters for each field, there would be a theoretical total of 36¹⁰²⁸ possible combinations, so releasing container identifiers for re-use may not occur often.

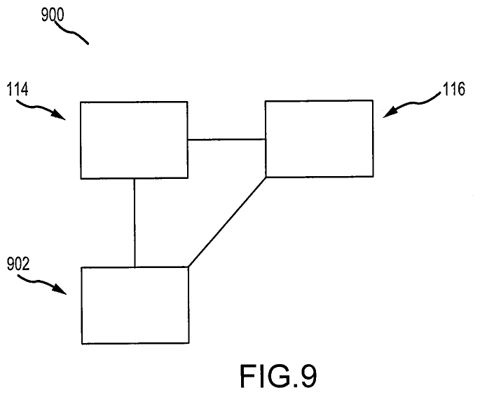

With reference to FIG. 9, recycling facilitation distributed system 900 is illustrated. Recycling operator 902 may comprise a system of an entity that operates or otherwise is involved in recycling activities. Recycling operator 902 may receive container 110, with momentary reference to FIG. 1, for recycling and may scan container 110 to obtain the container identifier 140. Recycling operator 902 may pass confirmation information to recycling facilitation system 114 and facilitation system 114 may, in turn, pass this information to incentive system 116. Confirmation information may comprise the container identifier 140, the identity and location of recycling operator 902, and a time stamp. In this manner, it is confirmed that container 110 was actually presented for recycling. In various embodiments, however, recycling operator 902 may pass confirmation information directly to incentive system 116. Recycling facilitation system 114 may match the confirmation information from recycling operator 902 from the data regarding where container 110 was presented for recycling. This allows recycling facilitation system 114 to aggregate data across users to determine the geographic recycling efforts of various users and helps to identify areas where further market penetration are available as well as identify areas where existing users can improve their recycling habits. Moreover, recycling facilitation system 114 could, over time, determine whether there were particular users who have lower rates of in fact presenting containers for recycling. Incentive system 116 may use data from recycling operator 902 to further improve its incentivization efforts.

Systems and methods in various embodiments may provide enhanced incentives to participate in recycling, both at home and on the go. Instead of collecting and hauling containers to a centralized facility and dealing with coins in small denominations, systems and method disclosed herein allow for convenient redemption of incentives. Incentives can be accumulated over time and paid out in meaningful amounts. Moreover, incentives may be converted from one form to another in order to enhance the benefits of the incentive. For example, by paying premiums to convert incentives to gift cards, the systems herein shift funds to be used at a single merchant or other business. By aggregating incentives over time, the operator of such a system may benefit from the daily interest payments on these funds over the course of months it would typically take to accumulate meaningful rewards. Further still, litter may be reduced as there are incentives to properly dispose of containers.

The technologies described herein may be incorporated into any of the components, devices, and systems described herein.

In various embodiments, user device 112, receiving account 142, recycling facilitation system 114, incentive system 116 and recycling interface 108, and other systems may incorporate hardware and/or software components. For example, a web client running on a merchant device, user device, incentive system, receiving account, recycling facilitation system, or the like may comprise a server appliance running a suitable server operating system (e.g., MICROSOFT INTERNET INFORMATION SERVICES or, “IIS”). Web client 150 may be any device that allows a user to communicate with a network (e.g., a personal computer, personal digital assistant (e.g., IPHONE®, BLACKBERRY*), tablet, cellular phone, kiosk, and/or the like). De includes any device (e.g., personal computer, mobile device, etc.) which communicates via any network, for example such as those discussed herein. In various embodiments, user device 112, receiving account 142, recycling facilitation system 114, incentive system 116 and recycling interface 108, and other systems may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with a server via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, browser may be configured to display an electronic channel.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a payment form and (ii) an address. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

For example, user device 112, receiving account 142, recycling facilitation system 114, incentive system 116 and recycling interface 108 may comprise a server appliance running a suitable server operating system (e.g., MICROSOFT INTERNET INFORMATION SERVICES or, “IIS”) and having database software (e.g., ORACLE) installed thereon. User device 112, receiving account 142, recycling facilitation system 114, incentive system 116 and recycling interface 108 may be in electronic communication with one another, either directly or through various intermediaries and/or networks.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

An online merchant, as used herein, may also be an online marketplace. An online marketplace may be an online seller of goods and services that sells both goods and services from its own inventory and from the inventory of other sellers that have access to the online marketplace.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of the system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: gift card data, transaction card data, credit card data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

The systems, computers, computer-based systems, and the like disclosed herein may provide a suitable website or other internet-based graphical user interface which is accessible by users.

Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf, which is hereby incorporated by reference in its entirety.

In various embodiments, the system and various components may integrate with one or more smart digital assistant technologies. For example, exemplary smart digital assistant technologies may include the ALEXA system developed by AMAZON®, GOOGLE HOME®, APPLE® HOMEPOD®, and/or similar digital assistant technologies. AMAZON® ALEXA, GOOGLE HOME®, and APPLE® HOMEPOD®, may each provide cloud-based voice activation services that can assist with tasks, entertainment, general information, and more. All AMAZON® ALEXA devices, such as the AMAZON ECHO®, AMAZON ECHO DOT®, AMAZON TAP®, and AMAZON FIRE® TV, have access to the ALEXA system. The ALEXA, GOOGLE HOME®, and APPLE® HOMEPOD® systems may receive voice commands via its voice activation technology, and activate other functions, control smart devices, and/or gather information. For example, the smart digital assistant technologies may be used to interact with music, emails, texts, calling, question answering, home improvement information, smart home communication/activation, games, shopping, making to-do lists, setting alarms, streaming podcasts, playing audiobooks, and providing weather, traffic, and other real time information, such as news. The ALEXA, GOOGLE HOME®, and APPLE® HOMEPOD® systems may also allow the user to access information about eligible transaction accounts linked to an online account across all digital assistant-enabled devices.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT and XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In various embodiments, one or more servers discussed herein may include application servers (e.g., WEBSPHERE®, WEBLOGIC®, JBOSS®, POSTGRES PLUS ADVANCED SERVER®, etc.). In various embodiments, the server may include web servers (e.g. Apache, IIS, GOGGLE® Web Server, SUN JAVA® System Web Server, JAVA® Virtual Machine running on LINUX® or WINDOWS® operating systems, etc.).

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, integrated into any other application server components, reside within another computing device, or take the form of a standalone hardware component.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

As will be appreciated by one of ordinary skill in the art, the system or any of its components may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager such as, for example, Parallel Multithreaded Machine (“PM2”); a resource and performance monitoring tool such as, for example, Node Application Metrics (“appmetrics”); a library module for building user interfaces, and/or any other suitable and/or desired module.

As used herein, “electronic communication” may comprise a physical coupling and/or non-physical coupling capable of enabling system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection. All user device 112, receiving account 142, recycling facilitation system 114, incentive system 116 and recycling interface 108, and the like may be in electronic communication with one another.

As used herein, “transmit” may include sending electronic data from one system component to another over a network connection. Additionally, as used herein, “data” or “information” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U. S. C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, at a recycling facilitation system, a container identifier from a recycling interface;
authenticating, by the recycling facilitation system, the container identifier;
determining, by the recycling facilitation system, at least one of an availability or an identity of an incentive; and
distributing, by the recycling facilitation system, the incentive.

2. The method of claim 1, wherein the recycling interface obtains the container identifier from at least one of a bar code, a QR code, and an RFID associated with a container.

3. The method of claim 2, wherein the receiving is facilitated via at least one of an NFC interface, a Bluetooth interface, and a wireless Ethernet interface.

4. The method of claim 1, further comprising determining, by the recycling facilitation system, a geographic location of the recycling interface and wherein the distributing comprises at least one of making a cash deposit into an account, transferring cryptocurrency via a distributed ledger, and making a deposit into a gift card.

5. The method of claim 4, further comprising transmitting, by the recycling facilitation system, the geographic location of the recycling interface to an incentive system.

6. The method of claim 5, further comprising receiving, by the recycling facilitation system, a determination of whether the container identifier has previously been recognized by the incentive system.

7. The method of claim 2, further comprising receiving, by the recycling facilitation system from a container manufacturer/distributor, the container identifier at least one of before and after the container manufacturer/distributor affixes the container identifier to the container.

8. An article of manufacture comprising:
a non-transitory, machine-readable memory having instructions recorded thereon that, in response to execution by a recycling facilitation system, cause the recycling facilitation system to perform operations comprising:
receiving, at the recycling facilitation system, a container identifier from a recycling interface;
authenticating, by the recycling facilitation system, the container identifier;
determining, by the recycling facilitation system, at least one of the availability or identity of an incentive; and
distributing, by the recycling facilitation system, the incentive.

9. The article of manufacture of claim 8, wherein the recycling interface obtains the container identifier from at least one of a bar code, a QR code, and an RFID associated with a container.

10. The article of manufacture of claim 9, wherein the receiving is facilitated via at least one of an NFC interface, a Bluetooth interface, and a wireless Ethernet interface.

11. The article of manufacture of claim 8, wherein the operations further comprise determining, by the recycling facilitation system, a geographic location of the recycling interface.

12. The article of manufacture of claim 11, wherein the operations further comprise transmitting, by the recycling facilitation system to an incentive system, the geographic location of the recycling interface and wherein the distributing comprises at least one of making a cash deposit into an account, transferring cryptocurrency via a distributed ledger, and making a deposit into a gift card.

13. The article of manufacture of claim 12, wherein the operations further comprise receiving, by the recycling facilitation system, a determination of whether the container identifier has previously been recognized by the incentive system.

14. The article of manufacture of claim 9, wherein the operations further comprise receiving, by the recycling facilitation system from a container manufacturer/distributor, the container identifier at least one of before and after the container manufacturer/distributor affixes the container identifier to the container.

15. A recycling facilitation receptacle comprising:
at least one of a lid or a vessel coupled to a recycling interface, the recycling interface comprising:
a processor;
an optical sensor in communication with the processor; and
a tangible, non-transitory memory configured to communicate with the processor, the tangible, non-transitory memory having instructions stored thereon that, in response to execution by the processor, cause the processor to perform operations comprising:
receiving, by the processor and from the optical sensor, a container identifier; and
commanding, by the processor, a communications interface to transmit to a recycling facilitation system, the container identifier.

16. The recycling facilitation receptacle of claim 15, wherein the optical sensor obtains the container identifier from at least one of a bar code and a QR code associated with a container.

17. The recycling facilitation receptacle of claim 16, wherein the communications interface comprises at least one of an NFC interface, a Bluetooth interface, and a wireless Ethernet interface.

18. The recycling facilitation receptacle of claim 15, wherein the operations further comprise commanding, by the processor, the communications interface transmit to the recycling facilitation system, a geographic location of the recycling interface and wherein the distributing comprises at least one of making a cash deposit into an account, transferring cryptocurrency via a distributed ledger, and making a deposit into a gift card.

19. The recycling facilitation receptacle of claim 15, wherein the operations further comprise receiving, by the processor, a determination of whether the container identifier has previously been recognized by an incentive system.

20. The recycling facilitation receptacle of claim 15, wherein the operations further comprise receiving, by the processor, identification from a user device.
